(19) United States
(12) Patent Application Publication
(10) Pub. No.: US 2026/0267649 A1
(43) Pub. Date: Sep. 10, 2026

(54) ACCELERATED TAGE BRANCH PREDICTION WITH A TAGE CACHE

(71) Applicant: Akeana, Inc., Santa Clara, CA (US)

(72) Inventors: Edwin R Sutanto, Freemont, CA (US); Rabin Sugumar, Sunnyvale, CA (US)

(73) Assignee: Akeana, Inc., Santa Clara, CA (US)

(21) Appl. No.: 19/658,832

(22) Filed: Apr. 27, 2026

Related U.S. Application Data
(63) Continuation-in-part of application No. 19/268,170, filed on Jul. 14, 2025.
Application No. 19/268,170 is a continuation of application No. 18/534,786, filed on Dec. 11, 2023, now Pat. No. 12,360,769.
(60) Provisional application No. 63/431,756, filed on Dec. 12, 2022.
(60) Provisional application No. 63/434,104, filed on Dec. 21, 2022.
(60) Provisional application No. 63/435,343, filed on Dec. 27, 2022.
(60) Provisional application No. 63/435,831, filed on Dec. 29, 2022.
(60) Provisional application No. 63/436,133, filed on Dec. 30, 2022.
(60) Provisional application No. 63/436,144, filed on Dec. 30, 2022.
(60) Provisional application No. 63/439,761, filed on Jan. 18, 2023.
(60) Provisional application No. 63/444,619, filed on Feb. 10, 2023.
(60) Provisional application No. 63/462,542, filed on Apr. 28, 2023.
(60) Provisional application No. 63/463,371, filed on May 2, 2023.
(60) Provisional application No. 63/467,335, filed on May 18, 2023.
(60) Provisional application No. 63/471,283, filed on Jun. 6, 2023.
(60) Provisional application No. 63/521,365, filed on Jun. 16, 2023.
(60) Provisional application No. 63/526,009, filed on Jul. 11, 2023.
(60) Provisional application No. 63/542,797, filed on Oct. 6, 2023.
(60) Provisional application No. 63/545,961, filed on Oct. 27, 2023.
(60) Provisional application No. 63/546,769, filed on Nov. 1, 2023.
(60) Provisional application No. 63/547,404, filed on Nov. 6, 2023.
(60) Provisional application No. 63/547,574, filed on Nov. 7, 2023.
(60) Provisional application No. 63/602,514, filed on Nov. 24, 2023.
(60) Provisional application No. 63/605,620, filed on Dec. 4, 2023.
(60) Provisional application No. 63/679,192, filed on Aug. 5, 2024.
(60) Provisional application No. 63/679,685, filed on Aug. 6, 2024.
(60) Provisional application No. 63/687,795, filed on Aug. 28, 2024.
(60) Provisional application No. 63/690,822, filed on Sep. 5, 2024.
(60) Provisional application No. 63/691,351, filed on Sep. 6, 2024.
(60) Provisional application No. 63/699,245, filed on Sep. 26, 2024.
(60) Provisional application No. 63/702,192, filed on Oct. 2, 2024.
(60) Provisional application No. 63/714,529, filed on Oct. 31, 2024.
(60) Provisional application No. 63/719,841, filed on Nov. 13, 2024.
(60) Provisional application No. 63/730,997, filed on Dec. 12, 2024.
(60) Provisional application No. 63/735,937, filed on Dec. 19, 2024.
(60) Provisional application No. 63/745,432, filed on Jan. 15, 2025.
(60) Provisional application No. 63/764,198, filed on Feb. 27, 2025.
(60) Provisional application No. 63/765,094, filed on Feb. 28, 2025.
(60) Provisional application No. 63/777,814, filed on Mar. 26, 2025.
(60) Provisional application No. 63/795,829, filed on Apr. 28, 2025.
(60) Provisional application No. 63/797,195, filed on Apr. 30, 2025.
(60) Provisional application No. 63/803,977, filed on May 12, 2025.
(60) Provisional application No. 63/831,282, filed on Jun. 27, 2025.
(60) Provisional application No. 63/844,802, filed on Jul. 16, 2025.
(60) Provisional application No. 63/854,877, filed on Jul. 31, 2025.
(60) Provisional application No. 63/870,916, filed on Aug. 27, 2025.
(60) Provisional application No. 63/899,591, filed on Oct. 15, 2025.
(60) Provisional application No. 63/914,824, filed on Nov. 10, 2025.
(60) Provisional application No. 63/941,793, filed on Dec. 16, 2025.
(60) Provisional application No. 63/983,964, filed on Feb. 16, 2026.
(60) Provisional application No. 64/039,799, filed on Apr. 15, 2026.
(60) Provisional application No. 64/042,050, filed on Apr. 17, 2026.

(51) Int. Cl. G06F 9/38; G06F 12/0875

(52) U.S. Cl. CPC G06F 9/3806; G06F 12/0875; G06F 2212/452

(57) ABSTRACT

A processor core is accessed. The processor core executes a plurality of instructions. The processor core includes a tagged geometric (TAGE) branch predictor and a TAGE cache. A conditional branch instruction is predicted by the processor core. The predicting is based on the TAGE branch predictor. The predicting results in a first prediction. A previous TAGE prediction associated with the conditional branch instruction is searched for in the TAGE cache. The predicting and the searching occur in parallel. A next instruction is fetched by the processor core from an instruction cache. The fetching is based on the predicting and the searching. The searching results in a hit within the TAGE cache and results in a second prediction. The fetching is based on the second prediction. The first prediction is compared with the second prediction. The fetching is restarted when the first prediction and the second prediction do not match.

### RELATED APPLICATIONS

This application claims the benefit of U.S. provisional patent applications “Accelerated TAGE Branch Prediction With A TAGE Cache” Ser. No. 63/795,829, filed Apr. 28, 2025, “Branch Prediction With Next Program Counter Caches” Ser. No. 63/797,195, filed Apr. 30, 2025, “Weight-Stationary Matrix Multiply Acceleration With A Prefilled Memory Hierarchy” Ser. No. 63/803,977, filed May 12, 2025, “Single Cycle Move Instruction Elimination With Multiple Dependencies In A Dispatch Bundle” Ser. No. 63/831,282, filed Jun. 27, 2025, “In-Order Multithreading With Dispatch Bundle Packing” Ser. No. 63/844,802, filed Jul. 16, 2025, “AI Compute Clusters With Noncoherent Shared SRAM” Ser. No. 63/854,877, filed Jul. 31, 2025, “In-Order Multithreading With Pipeline Flush And Instruction Replay” Ser. No. 63/870,916, filed Aug. 27, 2025, “Invalidating Snoop Avoidance With Multiple Atomic Loops” Ser. No. 63/899,591, filed Oct. 15, 2025, “Matrix Multiply Acceleration Based On A Static Partitioning History Table” Ser. No. 63/914,824, filed Nov. 10, 2025, “Hierarchical Performance-Based Scheduler For Data Center Workloads” Ser. No. 63/941,793, filed Dec. 16, 2025, “Memory Latency Hiding With A Memory Accelerator” Ser. No. 63/983,964, filed Feb. 16, 2026, “Executing Floating Point Instructions In A Plurality Of Formats With Common Hardware” Ser. No. 64/039,799, filed Apr. 15, 2026, and “Vector Instruction Execution With Vector Length Set To Zero” Ser. No. 64/042,050, filed Apr. 17, 2026.

This application is also a continuation-in-part of U.S. patent application “Branch Prediction With Next Program Counter Caches” Ser. No. 19/268,170, filed Jul. 14, 2025, which claims the benefit of U.S. provisional patent applications “Weight-Stationary Matrix Multiply Accelerator With Tightly Coupled L2 Cache” Ser. No. 63/679,192, filed Aug. 5, 2024, “Non-Blocking Vector Instruction Dispatch With Micro-Operations” Ser. No. 63/679,685, filed Aug. 6, 2024, “Atomic Compare And Swap Using Micro-Operations” Ser. No. 63/687,795, filed Aug. 28, 2024, “Atomic Updating Of Page Table Entry Status Bits” Ser. No. 63/690,822, filed Sep. 5, 2024, “Adaptive SOC Routing With Distributed Quality-Of-Service Agents” Ser. No. 63/691,351, filed Sep. 6, 2024, “Communications Protocol Conversion Over A Mesh Interconnect” Ser. No. 63/699,245, filed Sep. 26, 2024, “Non-Blocking Unit Stride Vector Instruction Dispatch With Micro-Operations” Ser. No. 63/702,192, filed Oct. 2, 2024, “Non-Blocking Vector Instruction Dispatch With Micro-Element Operations” Ser. No. 63/714,529, filed Oct. 31, 2024, “Vector Floating-Point Flag Update With Micro-Operations” Ser. No. 63/719,841, filed Nov. 13, 2024, “Shadow Stack Management With Micro-Operations” Ser. No. 63/730,997, filed Dec. 12, 2024, “Systolic Array Matrix-Multiply Accelerator With Row Tail Accumulation” Ser. No. 63/735,937, filed Dec. 19, 2024, “Non-Flushing Vector Micro-Operations With VSET” Ser. No. 63/745,432, filed Jan. 15, 2025, “Precalculated Routing Information In A Coherent Mesh Network” Ser. No. 63/764,198, filed Feb. 27, 2025, “Transformed Activation Function With ISA Extension” Ser. No. 63/765,094, filed Feb. 28, 2025, “Vector Unit With An Activation Function Accelerator Pipeline” Ser. No. 63/777,814, filed Mar. 26, 2025, “Accelerated TAGE Branch Prediction With A TAGE Cache” Ser. No. 63/795,829, filed Apr. 28, 2025, “Branch Prediction With Next Program Counter Caches” Ser. No. 63/797,195, filed Apr. 30, 2025, “Weight-Stationary Matrix Multiply Acceleration With A Prefilled Memory Hierarchy” Ser. No. 63/803,977, filed May 12, 2025, and “Single Cycle Move Instruction Elimination With Multiple Dependencies In A Dispatch Bundle” Ser. No. 63/831,282, filed Jun. 27, 2025.

The U.S. patent application “Branch Prediction With Next Program Counter Caches” Ser. No. 19/268,170, filed Jul. 14, 2025 is also a continuation-in-part of U.S. patent application “Branch Target Buffer Operation With Auxiliary Indirect Cache” Ser. No. 18/534,786, filed Dec. 11, 2023, which issued as U.S. patent Ser. No. 12/360,769 on Jul. 15, 2025, which claims the benefit of U.S. provisional patent applications “Branch Target Buffer Operation With Auxiliary Indirect Cache” Ser. No. 63/431,756 filed Dec. 12, 2022, “Processor Performance Profiling Using Agents” Ser. No. 63/434,104, filed Dec. 21, 2022, “Prefetching With Saturation Control” Ser. No. 63/435,343, filed Dec. 27, 2022, “Prioritized Unified TLB Lookup With Variable Page Sizes” Ser. No. 63/435,831, filed Dec. 29, 2022, “Return Address Stack With Branch Mispredict Recovery” Ser. No. 63/436,133, filed Dec. 30, 2022, “Coherency Management Using Distributed Snoop” Ser. No. 63/436,144, filed Dec. 30, 2022, “Cache Management Using Shared Cache Line Storage” Ser. No. 63/439,761, filed Jan. 18, 2023, “Access Request Dynamic Multilevel Arbitration” Ser. No. 63/444,619, filed Feb. 10, 2023, “Processor Pipeline For Data Transfer Operations” Ser. No. 63/462,542, filed Apr. 28, 2023, “Out-Of-Order Unit Stride Data Prefetcher With Scoreboarding” Ser. No. 63/463,371, filed May 2, 2023, “Architectural Reduction Of Voltage And Clock Attach Windows” Ser. No. 63/467,335, filed May 18, 2023, “Coherent Hierarchical Cache Line Tracking” Ser. No. 63/471,283, filed Jun. 6, 2023, “Direct Cache Transfer With Shared Cache Lines” Ser. No. 63/521,365, filed Jun. 16, 2023, “Polarity-Based Data Prefetcher With Underlying Stride Detection” Ser. No. 63/526,009, filed Jul. 11, 2023, “Mixed-Source Dependency Control” Ser. No. 63/542,797, filed Oct. 6, 2023, “Vector Scatter And Gather With Single Memory Access” Ser. No. 63/545,961, filed Oct. 27, 2023, “Pipeline Optimization With Variable Latency Execution” Ser. No. 63/546,769, filed Nov. 1, 2023, “Cache Evict Duplication Management” Ser. No. 63/547,404, filed Nov. 6, 2023, “Multi-Cast Snoop Vectors Within A Mesh Topology” Ser. No. 63/547,574, filed Nov. 7, 2023, “Optimized Snoop Multi-Cast With Mesh Regions” Ser. No. 63/602,514, filed Nov. 24, 2023, and “Cache Snoop Replay Management” Ser. No. 63/605,620, filed Dec. 4, 2023.

Each of the foregoing applications is hereby incorporated by reference in its entirety.

### FIELD OF ART

This application relates generally to instruction execution and more particularly to accelerated tagged geometric (TAGE) branch prediction with a TAGE cache.

### BACKGROUND

Fast processors are the backbone of modern computing equipment, enabling everything from everyday tasks to the most advanced applications in science, business, and entertainment. As computing demands continue to evolve, the importance of processor performance has only grown. A faster processor can execute more instructions per second, reducing the time required to complete tasks and enhancing the responsiveness of systems. In devices such as desktops, mobile devices, data centers, and embedded systems, processing speed directly influences user experience, productivity, and the practical capabilities of the software running on the device.

New applications that push the limits of what current hardware can deliver are constantly being developed. In particular, emerging fields such as blockchain, artificial intelligence (AI), and image processing depend heavily on rapid computation. Blockchain applications, for example, require substantial processing power to perform cryptographic hashing and to verify transactions across distributed networks. In AI, training and inference of deep learning models demand high-speed data movement and complex matrix operations that are accelerated by powerful processors. Image and video processing workflows, especially at high resolutions or real-time frame rates, benefit greatly from processors that can handle parallel computations efficiently and without delay. Improvements in processor efficiency can translate directly into faster model training, more responsive AI inference, and quicker image rendering. Moreover, in robotics and autonomous systems, high performance processors are essential for navigation and control. Autonomous vehicles, for example, rely on processing power to ingest GPS data, sensor input, and planned paths to make split-second driving decisions.

Beyond professional and technical applications, fast processors are equally essential for consumer-oriented experiences. Modern gaming, simulation software, and multimedia platforms rely on computational speed. Gaming, for instance, involves not just high-fidelity graphics, but also real-time physics, AI-controlled characters, and intricate world-building systems, all of which place a heavy burden on the processor. Simulations in fields such as engineering, finance, and health care depend on fast computation to deliver accurate results within useful time frames. In the field of content creation, multimedia tasks such as 4K video editing, streaming, and rendering are increasingly performed on consumer devices that make use of strong processor performance to maintain smooth playback and real-time editing capabilities. As user expectations continue to grow, these applications continue to demand higher performance from processors.

Moreover, processor advancements can often unlock system-wide efficiencies. Fast processors can reduce energy consumption by completing tasks more quickly and entering low-power states sooner. They also can enable more effective multitasking, allowing users to run several intensive applications simultaneously without noticeably reduced performance. As hardware becomes more interconnected, such as through edge computing, smart devices, and cloud services, fast processors ensure that performance remains consistent and reliable, regardless of where the computation is performed. Thus, fast processors play an important role in supporting the expanding range of computational tasks across all domains. From breakthrough technologies such as AI and blockchain to daily needs such as gaming and media processing, processor speed continues to be a fundamental driver of innovation, usability, and system capability. As software complexity increases and new use cases emerge, the demand for faster, more efficient processors will only continue to grow.

### SUMMARY

As clock speeds approach practical and physical limits, due to factors such as heat dissipation, power consumption, and diminishing returns from increased clock frequency, it is becoming increasingly important to consider architectural improvements to extract greater performance from a processor. One of the most important components in this domain is branch prediction. In modern pipelined processors, especially reduced instruction set computing (RISC) architectures, branch prediction can play a pivotal role in maintaining high instruction throughput. Since instructions can be fetched and executed speculatively, the ability to accurately predict the outcome of conditional branches can drastically reduce the number of pipeline stalls and wasted cycles. Every mispredicted branch can result in flushing the pipeline, which not only wastes cycles, but also disrupts the flow of instruction-level parallelism. Therefore, effective branch prediction is an essential part of an overall processor performance strategy. Disclosed implementations can enable the processor to leverage the accuracy of the full TAGE predictor while providing a low-latency fast path for common or recently seen prediction scenarios. In disclosed implementations, the TAGE cache can serve as a short-term memory for the TAGE branch predictor by capturing and reusing the predictions for patterns that occur with high temporal locality. By doing so, the pipeline can speculatively fetch from the predicted target immediately after a cache hit, avoiding the multiple cycle delay that can be associated with full TAGE branch predictor evaluation.

A processor core is accessed. The processor core executes a plurality of instructions. The processor core includes a tagged geometric (TAGE) branch predictor and a TAGE cache. A conditional branch instruction is predicted by the processor core. The predicting is based on the TAGE branch predictor. The predicting results in a first prediction. A previous TAGE prediction associated with the conditional branch instruction is searched for in the TAGE cache. The predicting and the searching occur in parallel. A next instruction is fetched by the processor core from an instruction cache. The fetching is based on the predicting and the searching. The searching results in a hit within the TAGE cache and results in a second prediction. The fetching is based on the second prediction. The first prediction is compared with the second prediction. The fetching is restarted when the first prediction and the second prediction do not match.

A processor-implemented method for instruction execution is disclosed comprising: accessing a processor core, wherein the processor core executes a plurality of instructions, and wherein the processor core includes a tagged geometric (TAGE) branch predictor and a TAGE cache; predicting, by the processor core, a conditional branch instruction, wherein the predicting is based on the TAGE branch predictor, and wherein the predicting results in a first prediction; searching, in the TAGE cache, for a previous TAGE branch prediction associated with the conditional branch instruction, wherein the predicting and the searching occur in parallel; and fetching, by the processor core, from an instruction cache, a next instruction, wherein the fetching is based on the predicting and the searching. In embodiments, the searching results in a hit within the TAGE cache, wherein the searching results in a second prediction. In embodiments, the fetching is based on the second prediction. Some embodiments comprise comparing the first prediction with the second prediction. Some embodiments comprise restarting the fetching, wherein the restarting is based on the first prediction, wherein the first prediction and the second prediction do not match. Some embodiments comprise updating the TAGE cache with the first prediction.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for accelerated TAGE branch prediction with a TAGE cache.

FIG. 2 is a flow diagram for searching a TAGE cache.

FIG. 3 is a diagram of a two-bit branch history table.

FIG. 4 is a diagram of a global history register.

FIG. 5 is a diagram for a tagged geometric (TAGE) branch predictor.

FIG. 6 is a diagram for comparing results of a TAGE branch predictor and TAGE cache.

FIG. 7 is a block diagram of a multicore processor.

FIG. 8 is a block diagram of a pipeline.

FIG. 9 is a design flow for semiconductor logic generation.

FIG. 10 is a system diagram for accelerated TAGE branch prediction with a TAGE cache.

### DETAILED DESCRIPTION

Speculative execution is a technique used in modern processors to improve performance by predicting the outcome of conditional branches and executing instructions ahead of time. While this approach can significantly enhance efficiency when predictions are correct, it has notable disadvantages when branch predictions are incorrect. When a branch prediction is incorrect, the processor must discard the results of speculatively executed instructions. These wasted computations do not contribute to program progress, and they reduce overall efficiency. In response to a branch misprediction, the processor pipeline is cleared (flushed), and correct instructions from the actual branch are refetched and re-executed. This incurs a delay known as a branch prediction penalty, which can negatively impact processor performance along with the power consumption contributed by the wasted computations. Recovering from a mispredicted branch requires re-executing the correct path, increasing latency.

The significance of branch prediction becomes even more pronounced in deeply pipelined or superscalar processors, where multiple instructions are fetched and executed in parallel. A single misprediction can cause the performance and power loss of many instructions that were speculatively fetched based on the wrong path. In this context, advanced branch predictors such as a TAGE (tagged geometric) branch predictor can be used. By leveraging long and variable branch histories with hashed indexing and tag-matching mechanisms, predictors such as a TAGE branch predictor can achieve remarkably high accuracy rates. Accurate branch prediction is especially important in workloads with complex control flow patterns, such as those found in artificial intelligence inference, real-time simulations, and compiled multimedia pipelines. In RISC processors, which emphasize a large number of relatively simple instructions, the high frequency of branches (due to shorter instruction sequences per task) makes accurate prediction even more important to keep the instruction pipeline filled, and to avoid performance bottlenecks.

Beyond just avoiding pipeline flushes, effective branch prediction also enables other performance-enhancing techniques such as speculative execution, instruction prefetching, and aggressive out-of-order execution. These mechanisms depend on the processor's ability to make intelligent guesses about future control flow, allowing the processor to prepare instructions ahead of time without waiting for actual outcomes to resolve. This kind of forward-looking execution model is well suited for extracting maximum performance from each processor cycle, particularly in a landscape where raw clock speeds offer limited headroom for improvement. Moreover, better prediction can translate into better energy efficiency by reducing unnecessary instruction fetches, memory accesses, and computation that would have to be discarded on a branch misprediction. In the age of mobile and embedded computing, where battery life and thermal limits are of high importance, energy efficiency becomes as important as instruction throughput.

While clock speed improvement also improves performance, frequency scaling (especially of long wires) and increased power (both from active current and leakage current) are significant detractors. Thus, innovations such as highly accurate branch prediction allow modern processors to continue scaling in performance. The aforementioned TAGE predictor is an effective mechanism for branch prediction. The TAGE predictor can combine multiple history lengths for better generalization. Moreover, the TAGE predictor uses tagged entries to help avoid aliasing and provides a good tradeoff between hardware costs and accuracy. However, while the TAGE predictor is an efficient branch predictor, one disadvantage of the TAGE predictor is the increased latency due to a relatively long access processing for today's processor speeds. A TAGE cache can be implemented to provide a branch location in fewer cycles, thereby improving processor performance. A TAGE cache stores recent prediction results from a TAGE branch predictor. The TAGE cache can be indexed by a hash of the program counter (PC) and any number of bits of the global branch history register. Disclosed implementations can mitigate a TAGE prediction disadvantage by providing a TAGE cache that is incorporated into the processor branch prediction. In disclosed implementations, the TAGE cache can be coupled to the TAGE branch predictor. When a branch instruction is fetched, the same hashed input used by the predictor can be simultaneously checked against the TAGE cache contents. If a match is found in the TAGE cache, the prediction can be speculatively used in the next cycle, significantly reducing fetch stalls and boosting instruction throughput.

A processor core is accessed. The processor core executes a plurality of instructions and includes a tagged geometric (TAGE) branch predictor and a TAGE cache. The processor core predicts a conditional branch instruction. The prediction is based on the TAGE branch predictor and results in a first prediction. The TAGE cache is searched for a previous TAGE prediction that is associated with the conditional branch instruction. The searching can result in a hit within the TAGE cache. The hit can result in a second prediction. The predicting and the searching occur in parallel. The processor core fetches a next instruction from an instruction cache. The fetching is based on the predicting and the searching. The fetching can be based on the second prediction from the TAGE cache. The first prediction and the second prediction can be compared. The fetching can be restarted based on the first prediction when the first prediction and the second prediction do not match. The TAGE cache can be updated with the first prediction from the TAGE branch predictor.

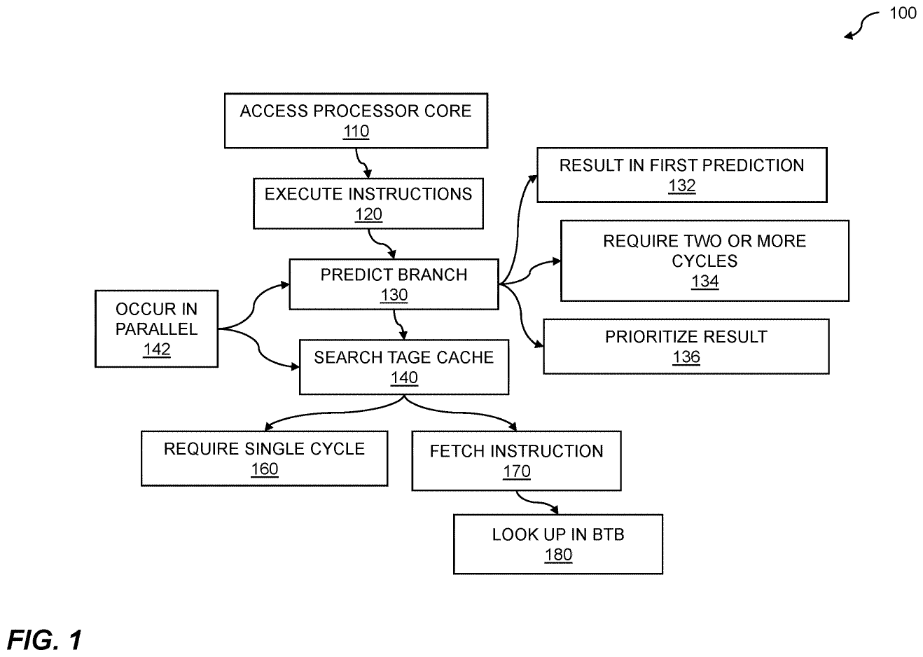

FIG. 1 is a flow diagram for accelerated TAGE branch prediction with a TAGE cache. The flow 100 includes accessing a processor core 110. The processor core can execute a plurality of instructions. The processor core can include a tagged geometric (TAGE) branch predictor and a TAGE cache. The processor core can be included on a multi-processor chip, an application specific integrated circuit (ASIC), a system-on-a-chip (SOC), and so on. The processor core can include a RISC-V® core, MIPS® core, ARM® core, and so on. In embodiments, the processor core is coupled to a memory hierarchy. The memory hierarchy can include multiple cache levels, memory, and/or other storage technologies. The processor core can execute instructions that are part of an instruction set architecture (ISA) such as X86, ARM, and so on. In implementations, the processor core is coupled to a memory hierarchy. The memory hierarchy can include L1, L2, L3, etc. caches. The memory hierarchy can include memory such as DRAM, SRAM, and so on. The memory hierarchy can be coherent or non-coherent.

The flow 100 further includes executing instructions 120. In disclosed implementations, the execution of instructions can be performed using a multi-stage pipeline. A first stage can include a fetch stage, in which the processor retrieves the next instruction from memory using the program counter (PC). A subsequent stage can include a decode stage, where the instruction is interpreted, and the necessary control signals are generated. During the decode stage, register operands can be read from the register file. An execute stage can follow the decode stage and can include performing arithmetic and/or logical operations by the arithmetic logic unit (ALU), or, in the case of branch instructions, executing the branch instruction.

The flow 100 further includes predicting a branch 130. The predicting can be accomplished by a processor core. The predicting involves a conditional branch instruction. The predicting can be based on the TAGE branch predictor, wherein the predicting results in a first prediction. Branch prediction is an important feature in modern processors that helps maintain smooth instruction flow by guessing the outcome of conditional branch instructions before they are fully resolved. In disclosed implementations, the branch prediction can utilize a TAGE branch predictor to estimate whether a given branch is likely to be taken (e.g., the program will jump to a different address) or not taken (e.g., execution continues sequentially). This decision allows the processor to speculatively fetch and execute instructions without waiting for the branch condition to be fully evaluated, thereby minimizing pipeline stalls.

The flow 100 can include making a prediction that results in a first prediction 132. The first prediction can be a prediction based on a TAGE branch predictor. In embodiments, the predicting can require two or more cycles 134 of the processor core. The TAGE branch predictor can require two or more clock cycles to produce a result due to its complex, multi-level structure designed for high prediction accuracy. Unlike simpler predictors that rely on a single pattern history table, a TAGE branch predictor may utilize a series of history tables, each indexed by increasingly longer global branch histories, allowing the TAGE branch predictor to capture both short-and long-term patterns in control flow behavior. To identify the best prediction, the predictor can evaluate multiple tables in parallel or in a prioritized sequence. This can involve traversing an array of cascaded multiplexers, each responsible for selecting between possible matching entries based on hashed program counters, history values, and tag matches. As a result, TAGE branch predictors may be pipelined and/or may utilize multiple cycles per result.

The flow 100 can further include prioritizing the result 136. In embodiments, the prioritizing is accomplished by the TAGE branch predictor. A result of a branch history table within the plurality of branch history tables can be associated with a longest history. In disclosed implementations, the prioritizing can include identifying the longest-history matching entry (the “provider”). In some implementations, the prioritizing can include examining not only the longest matching branch history, but also the second longest and/or third longest branch histories. These additional histories can serve to cross-check the reliability of the initial prediction. In disclosed implementations, when multiple history tables within the TAGE branch predictor agree with the longest matching history, the multi-level agreement can be used as a criterion to derive an enhanced confidence measure for the prediction. The number of tables in alignment can be indicative of higher certainty in the accuracy of the predicted branch outcome. This layered approach can potentially reduce misprediction rates by incorporating collective insights from several history lengths, strengthening the branch prediction mechanism overall.

The flow 100 can further include searching, in the TAGE cache 140. In embodiments, the searching, in the TAGE cache, for a previous TAGE prediction is associated with the conditional branch instruction. The predicting and the searching can occur in parallel. In disclosed implementations, the TAGE cache can be implemented as a fast-access memory structure that stores the prediction result, confidence, predicted target address, and/or a provider table index. Each entry can be tagged with a hashed combination of the PC and global history information. When a new PC value is provided to the TAGE branch predictor, the same hash can be used to probe the TAGE cache in parallel. If a match is found within the TAGE cache, the pipeline can use that prediction to start fetch and decode for the next cycle, essentially hiding the TAGE branch predictor latency behind the cache lookup. In disclosed implementations, a confidence factor, such as a factor based on the number of levels of TAGE branch predictor agreement, may be used as a criterion for speculative instruction execution.

To maintain coherence with the actual TAGE branch predictor, in disclosed implementations, each prediction from the full predictor can update the TAGE cache when a new prediction is committed and deemed accurate. In disclosed implementations, eviction and/or replacement policies, such as least-recently used (LRU) or least-frequently used (LFU), can be used to manage the limited space of the TAGE cache. For mispredictions and/or low-confidence cases, disclosed implementations may either stall fetch until the full prediction is resolved or override a speculative fetch as needed.

The flow 100 can include performing the predicting and searching such that the predicting and searching occur in parallel 142. Thus, disclosed implementations can provide a system combining a TAGE cache with a TAGE branch predictor that operates simultaneously, thereby providing the advantage of both speed and accuracy by leveraging the strengths of each component. The TAGE cache, able to return a prediction in a single clock cycle, acts as a fast-path mechanism, enabling the processor to begin speculative instruction fetch immediately without waiting for the full latency of the TAGE branch predictor. This is particularly valuable in high-performance pipelines where every cycle counts, as it allows execution to proceed with minimal delay. Meanwhile, the TAGE branch predictor, which may require two or more cycles to resolve due to its evaluation of multiple history tables and tag comparisons, continues processing in the background. If the TAGE branch predictor final result confirms the TAGE cache prediction, execution proceeds without interruption. However, in situations where the predictor disagrees with the cache result, disclosed implementations can correct the speculative path by flushing the pipeline and restarting fetch using the more accurate prediction. This hybrid approach can provide a balance between responsiveness and correctness, allowing the processor to exploit early fetch opportunities while still benefiting from the high accuracy of the full TAGE branch predictor. In this way, disclosed implementations can improve overall throughput and reduce performance penalties that can result from branch mispredictions.

The flow 100 can include searching, which requires a single cycle 160 of the processor core. The searching of the TAGE cache can be accomplished in a single cycle. Thus, the result from the TAGE cache can be available sooner than the TAGE branch prediction. In embodiments, the searching requires a single cycle of the processor core. In disclosed implementations, the single cycle can include obtaining a result from the TAGE cache based on a TAGE cache hit. The flow further includes fetching an instruction 170. The fetching, by the processor core, from an instruction cache, obtains a next instruction. The fetching of the instruction can be based on predicting and/or searching. The predicting can include predicting based on a result from the TAGE branch predictor. The searching can include searching the TAGE cache of disclosed implementations. In embodiments, the fetching includes looking up, in a branch target buffer 180, a target of the conditional branch instruction. In disclosed implementations, when a next instruction is ready to be fetched, the processor consults the branch target buffer (BTB) to retrieve the predicted target address of the next instruction. This allows the processor to speculatively fetch and execute instructions from the predicted target address without waiting for the actual branch to resolve (e.g., during execution). By enabling early decision-making on potential control flow changes, the BTB reduces the performance impact of branch instructions, particularly in deeply pipelined architectures. The combination of the BTB with the TAGE branch predictor and TAGE cache can increase the likelihood of correct branch predictions and can determine where to fetch the next set of instructions, enhancing overall execution efficiency.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors. Various embodiments of the flow 100, or portions thereof, can be included on a semiconductor chip and implemented in special purpose logic, programmable logic, and so on.

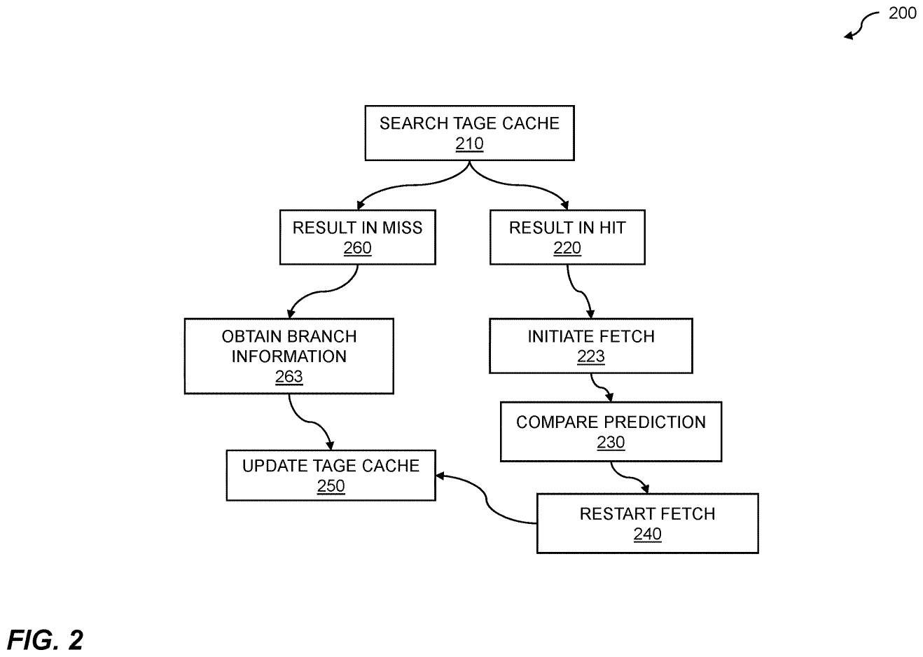

FIG. 2 is a flow diagram for searching a TAGE cache. The flow 200 starts with initiating searching of the TAGE cache 210. In some cases of the flow 200, the searching can result in a hit 220 within the TAGE cache. The searching can result in a second prediction. In disclosed implementations, the TAGE cache can be implemented as a direct mapped cache or set associative cache. Some implementations may utilize chained hashing for the TAGE cache. A TAGE cache hit occurs when a key value is found in the cache. In disclosed implementations, the key value may be found using direct mapping and/or set associative techniques. The flow 200 continues with initiating the fetch 223. The fetch can be based on the second prediction. The fetch can be performed based on the results from searching the TAGE cache. In embodiments, the fetching is based on the second prediction. The flow 200 can include comparing the first prediction 230 with the second prediction. The comparing can include comparing the prediction of “taken” or “not taken” for a branch within the TAGE cache with the prediction for the same branch as reported by the TAGE branch predictor. In disclosed implementations, the comparison may be performed at a later clock cycle than when the TAGE cache was searched. If the comparison between the TAGE cache and the TAGE branch predictor indicates a match, then the fetch that was initiated continues to completion. If the comparison between the TAGE cache and the TAGE branch predictor indicates a mismatch, then the flow 200 can continue with restarting the fetching 240, wherein the restarting is based on the first prediction. This occurs when the first prediction and the second prediction do not match. In this case, the prediction by the TAGE branch predictor takes precedence over information found in the TAGE cache. Embodiments can include restarting the fetching, wherein the restarting is based on the first prediction, wherein the first prediction and the second prediction do not match. The flow 200 then continues to update the TAGE cache 250, such that the TAGE cache includes the updated information regarding a specific branch. Thus, embodiments can include updating the TAGE cache with the first prediction.

The flow 200 can continue with updating the TAGE cache 250. The updating of the TAGE cache can be with the first prediction. The update to the TAGE cache includes updated information regarding a specific branch. In disclosed implementations, the TAGE cache was searched simultaneously with the TAGE branch predictor.

The flow 200 can include an instance where the searching results in a miss 260 within the TAGE cache. In this scenario, the entry is not found in the TAGE cache, and the flow 200 continues to obtain branch information 263. The obtaining of branch information can include obtaining a prediction from the TAGE branch predictor, and/or based on the results of an executed instruction, where it can then be determined with certainty if a given branch was taken. Fetching can then be accomplished, where the fetching is based on the first prediction. The first prediction can come from a TAGE branch predictor, and the flow can further comprise updating the TAGE cache with the first prediction.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors. Various embodiments of the flow 200, or portions thereof, can be included on a semiconductor chip and implemented in special purpose logic, programmable logic, and so on.

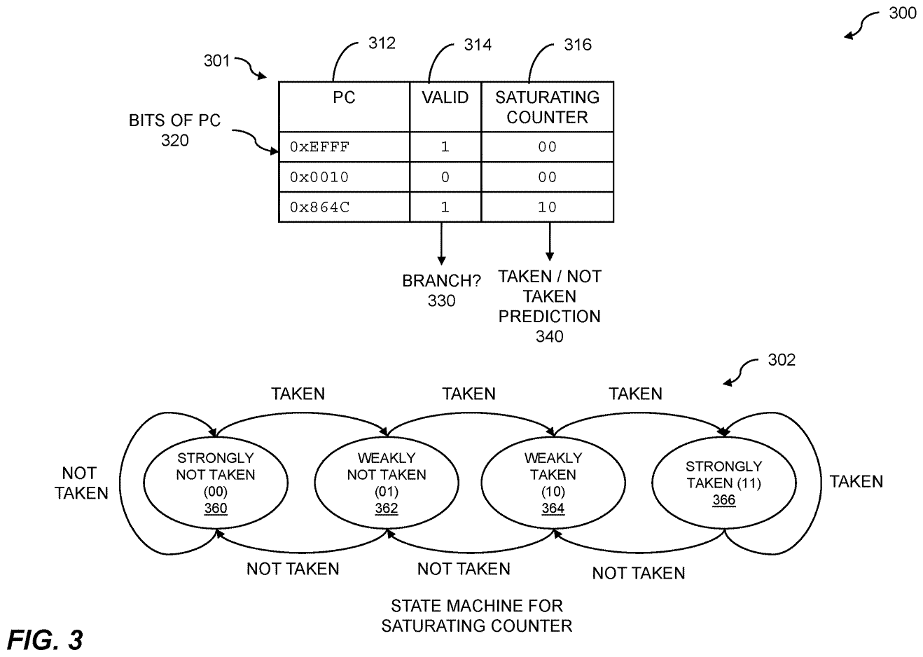

FIG. 3 is a diagram of a two-bit branch history table. The diagram 300 shows a branch history table 301, along with a corresponding state machine. The branch history table 301 includes a program counter (PC) column 312, a valid column 314, and a saturating counter column 316. The value in the PC column 312 can include the entire PC value or a subset of the PC bits 320, such as the lower 16 bits of the PC value. Using a subset of PC bits reduces table size and access latency, although it introduces the possibility of aliasing, where multiple distinct branches map to the same table entry. Although using a subset of the PC bits can result in aliasing, this effect is often tolerable or even negligible as the prediction algorithm tends to correct itself over time through repeated execution and feedback.

The valid column 314 can contain an indication of whether the instruction referenced by the PC value in column 312 is a branch instruction or a non-branch instruction 330. This bit acts as a quick filter, allowing the predictor to disregard entries that are not relevant for branch prediction. If the instruction is a non-branch instruction, then the next instruction fetched is sequential with respect to the current PC value. If the instruction is a branch instruction, the corresponding value in the saturating counter column 316 indicates if the branch is predicted to be taken or not taken 340. The saturating counter allows the predictor to retain a short history of recent outcomes for the branch, providing a degree of hysteresis to avoid overreacting to rare mispredictions. The saturating counter can enhance the stability and accuracy of the prediction mechanism, particularly in loops and other frequently branching structures.

Referring to the state machine 302, there is a first state of strongly not taken 360, corresponding to a two-bit value of 00. There is a second state of weakly not taken 362, corresponding to a two-bit value of 01. There is a third state of weakly taken 364, corresponding to a two-bit value of 10. There is a fourth state of strongly taken 366, corresponding to a two-bit value of 11. The 2-bit saturating counter of disclosed implementations can provide a simple yet effective mechanism for making and refining predictions based on past branch behavior. By using four states, strongly not taken (00), weakly not taken (01), weakly taken (10), and strongly taken (11), the saturating counter allows for a more nuanced decision process than a simple binary predictor. When a branch is taken, the saturating counter increments by one, up to a maximum of 11 (strongly taken). Conversely, when a branch is not taken, the saturating counter decrements down to a minimum of 00 (strongly not taken). The saturating counter enables a level of hysteresis, where a single unusual outcome does not immediately change the prediction direction. For instance, if a branch is typically taken and currently in the “strongly taken” state (11), a single unexpected non-taken outcome will only move the saturating counter to “weakly taken” (10). The next prediction will still assume the branch will be taken unless the non-taken result repeats, providing a stabilizing effect on the behavior of the taken/not taken prediction.

The advantages of this saturating counter approach are significant, especially in complex instruction streams where branches may occasionally deviate from their typical behavior due to noise, rare conditions, or control-flow edge cases. First, it reduces the likelihood of overreacting to one-off anomalies, which could otherwise cause unnecessary pipeline flushes and stalls. Second, the saturating counter of disclosed implementations allows for adaptive learning over time, in that branches that frequently change behavior will hover around the weakly taken/not taken states, while stable branches will settle into strongly biased states. This makes the predictor both responsive and robust. Additionally, the saturating counter of disclosed implementations is extremely hardware-efficient, requiring only two bits per entry and minimal logic to increment, decrement, and evaluate, making it ideal for high-speed, low-power prediction logic in RISC architectures as well as other types of architectures. While a 2-bit saturating counter is shown in diagram 300, other implementations can use more bits for the saturating counter, allowing for more states and finer granularity in tracking branch behavior. In general, the number of states is 2\hat{ }N, where N is the number of bits in the saturating counter. Thus, a 2-bit saturating counter results in four possible states, a 3-bit saturating counter results in eight possible states, and so on. Larger saturating counters can help improve prediction accuracy by requiring more consecutive mispredictions before changing the prediction outcome, but may also increase the time and/or logic required for saturating counter updates.

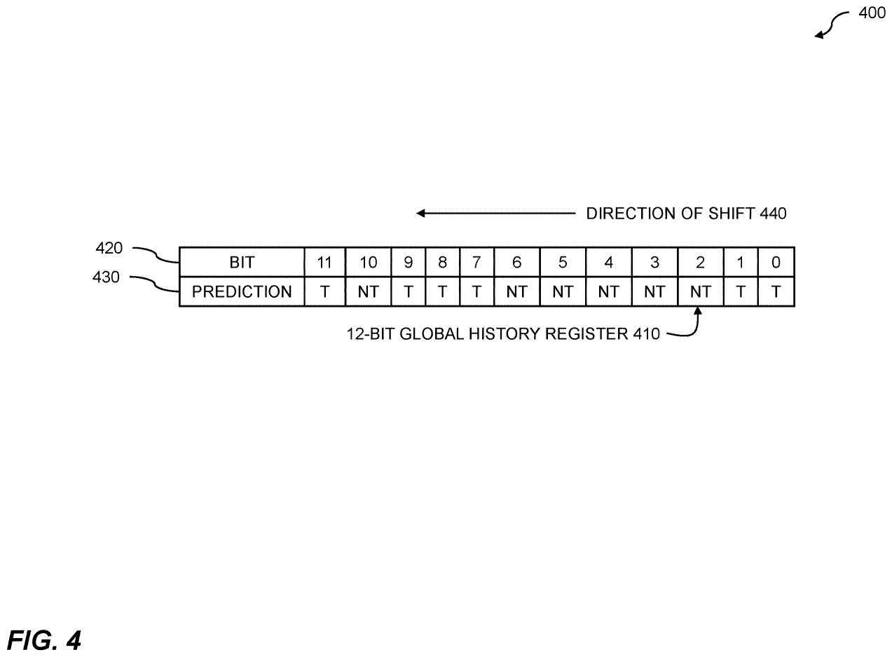

FIG. 4 is a diagram 400 of a global history register. For the purpose of explaining the operation of the global history register, the register 410 as shown is a 12-bit global history register. In practice, the global history register can be 64 bits, 128 bits, 256 bits, or another suitably sized register. Each bit 420 within the register 410 represents a temporal branch prediction occurrence. In disclosed implementations, the most recent branch instruction outcome is placed in bit 0 of register 410. When the next branch instruction outcome is available, the bits are shifted left, as indicated at 440. Each bit value stores the result of a prediction 430. As shown in diagram 400, an “NT” in a bit location is indicative of a branch not taken, and a “T” in a bit location is indicative of a branch being taken. In practice, a “1” in a bit location can be indicative of a branch being taken, and a “0” in a bit location can be indicative of a branch being not taken.

Since the TAGE branch predictor uses multiple lengths of branch history as part of the branch prediction, the portion of the register 410 that is used may undergo a folding process for hash creation. In disclosed implementations, the global history register 410 is 128 bits, and the hash input size is also 128 bits. Thus, in cases where a portion of the global history register 410 is used, the folding process expands the hash input to 128 bits in order to create the hash. As an example, for a TAGE branch predictor stage that uses 16 bits, the 16 bits are folded to create a 128-bit value to be used as input for the hash creation process. The folding can include simple bit replication. As an example, a 16-bit value can be repeated multiple times to fill a 128-bit register. For example, the value 0×1234 can be folded by bit replication to become 0×12341234123412341234123412341234. The folding can include bit rotation and XOR folding. This can include rotating the original bits and XORing the bits into other parts of the input. As an example, the folding can be performed using a process such as:

folded_value=val 51 (val<<16)|(val<<32)\hat{ }(val<<48)

The bit rotation approach can help distribute bits more than the bit replication technique, which can help reduce the probability of hash collisions. The folding can include mirroring and/or inversion, where bits are reversed and/or inverted in the replicated portions to introduce more variability, and also to reduce collisions. In some implementations, the folding mode can be specified by a register in a register file, enabling dynamic control over a folding strategy for different history lengths and/or execution contexts. The bit replication folding may be the fastest, but also may have a higher probability of collisions. The bit rotation, mirroring, and inversion techniques may require more time than the bit replication, but may also reduce the probability of collisions. Other implementations can include arithmetic mixing and/or multiplication with large prime constants to further increase entropy prior to hashing. In embodiments, the global history register includes a global branch history. In embodiments, the global branch history comprises 128-bits.

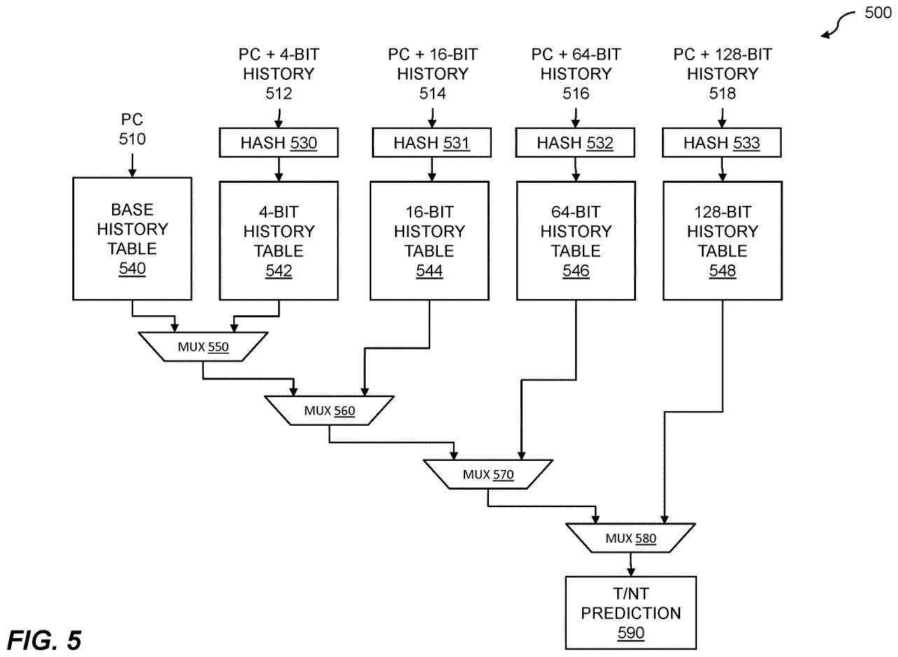

FIG. 5 is a diagram for a tagged geometric (TAGE) branch predictor 500. The TAGE branch predictor 500 includes a first stage that receives, as input, the program counter (PC) 510, or a portion of the bits of the PC 510 (e.g., the 16 least significant bits). The PC 510 is input to a base history table 540, which can be a standard 2-bit predictor table, a single bit predictor table, or another base predictor table. A second stage of the TAGE branch predictor 500 takes, as input, the PC and a 4-bit history 512, that is input to a hash process 530. The 4-bit history can be folded as previously described to obtain the required input size for the hash process 530. In the case of the 4-bit history and 128-bit hash input size, the 4-bit history that is derived from the global history register (as previously shown in FIG. 4) is folded 32 times to create the 128-bit input value for hash process 530. A third stage of the TAGE branch predictor 500 takes, as input, the PC and a 16-bit history 514 that is input to a hash process 531. The 16-bit history can be folded as previously described to obtain the required input size for the hash process 531. In the case of the 16-bit history and 128-bit hash input size, the 16-bit history that is derived from the global history register (as shown in FIG. 4) is folded eight times to create the 128-bit input value for hash process 531. A fourth stage of the TAGE branch predictor 500 takes, as input, the PC and a 64-bit history 516 that is input to a hash process 532. The 64-bit history can be folded as previously described to obtain the required input size for the hash process 532. In the case of the 64-bit history and 128-bit hash input size, the 64-bit history that is derived from the global history register (FIG. 4) is folded two times to create the 128-bit input value for hash process 532. A fifth stage of the TAGE branch predictor 500 takes, as input, the PC and a 128-bit history 518 that is input to a hash function 533. As the input length is equivalent to the required hashing input length, no folding is necessary for the fifth stage. Note that while five stages are shown in TAGE branch predictor 500, other implementations may have more or fewer stages. In embodiments, the TAGE branch predictor comprises a plurality of branch history tables. In embodiments, each branch history table within the plurality of branch history tables is accessed by a hash of a program counter and a global history register. In embodiments, each branch history table within the plurality of branch history tables comprises a different history length.

The outputs of each stage are fed to an arrangement of multiplexers. The results from base history table 540 and 4-bit history table 542 are input to multiplexer 550. The output of multiplexer 550 is input to multiplexer 560, and the output of 16-bit history table 544 is also input to multiplexer 560. The output of multiplexer 560 is input to multiplexer 570, and the output of 64-bit history table 546 is also input to multiplexer 570. The output of multiplexer 570 is input to multiplexer 580, and the output of 128-bit history table 548 is also input to multiplexer 580. The output of multiplexer 580 comprises the taken/not taken prediction 590. The logic within the multiplexers can provide a logical selection based on prediction availability or priority, such that the prediction provided by the longest matching history table is used for the final prediction output of the TAGE branch predictor 500. Embodiments can include prioritizing, by the TAGE branch predictor, a result of a branch history table within the plurality of branch history tables associated with a longest history. In some implementations, predictions based on other, shorter history table lengths may also be considered for deriving a prediction confidence value associated with the TAGE branch predictor output.

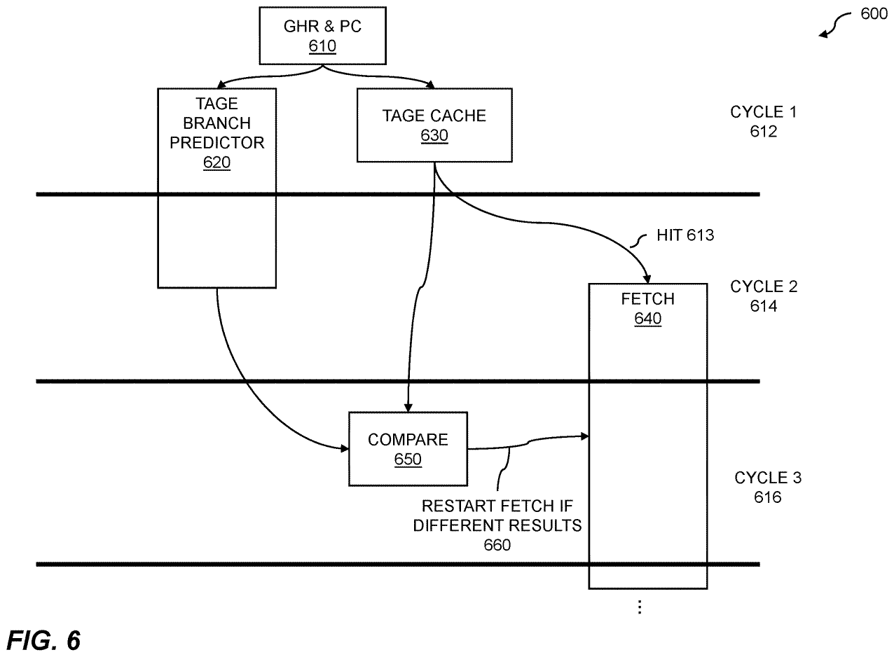

FIG. 6 is a diagram 600 for comparing results of a TAGE branch predictor and TAGE cache. The diagram 600 includes a combination of the global history register (GHR) and PC 610. The combination (e.g., formed by hashing and/or folding as necessary), is simultaneously input to both TAGE branch predictor 620 and TAGE cache 630. The TAGE branch predictor 620 can be similar to TAGE branch predictor 500 shown in FIG. 5. At cycle 1612, the TAGE cache 630 may return a hit 613, causing a speculative fetch 640 to start at cycle 2 614. The results from the TAGE branch predictor 620 may be available at cycle 2 614. At cycle 3 616, the results of the TAGE cache 630 and TAGE branch predictor 620 are compared at compare block 650. If the results of the TAGE cache 630 and TAGE branch predictor 620 agree, the speculative fetch 640 that was started at cycle 2 614 continues to completion. If instead, the results of the TAGE cache 630 and TAGE branch predictor 620 do not agree, the speculative fetch 640 that was started at cycle 2 614 is restarted 660, based on the results from the TAGE branch predictor 620.

Thus, disclosed implementations provide both a fast path and a slow path for branch prediction. The TAGE cache 630 can provide a low-latency prediction path that can deliver results in a single cycle, whereas the TAGE branch predictor 620, which can be more accurate than the TAGE cache 630 due to deeper history analysis, may require two or more cycles to produce a result. This fast-path capability allows for early speculation and improved instruction fetch bandwidth, helping to reduce pipeline stalls and increase overall processor throughput. By using the TAGE cache to initiate early fetches and verifying with the TAGE branch predictor, disclosed implementations can balance speed with accuracy. Even in cases where the speculative fetch is restarted, the overall latency impact across various instructions can be reduced compared to a design that relies solely on the TAGE branch predictor.

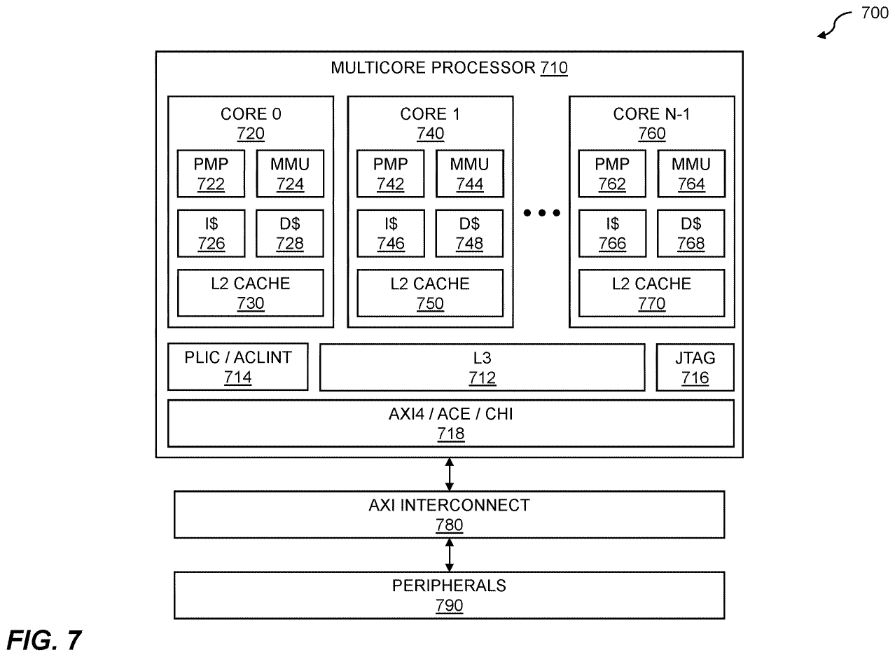

FIG. 7 is a block diagram of a multicore processor. The processor, such as a RISC-V® processor, an ARM® processor, or another suitable processor type, can include a variety of elements. The elements can include processor cores including multiprocessor cores, one or more caches including local caches and shared caches, memory protection and management units, local storage, and so on. The elements of the multicore processor can further include one or more of a private cache; a test interface such as a joint test action group (JTAG) test interface; one or more interfaces to a network such as a network-on-chip, shared memory, and peripherals; and the like.

In the block diagram 700, the multicore processor 710 can comprise two or more processors, where the two or more processors can include homogeneous processors, heterogeneous processors, etc. In the block diagram, the multicore processor can include N processor cores such as core 0 720, core 1 740, core N−1760, and so on. Each processor can comprise one or more elements. In one or more implementations, each core, including cores 0 through core N−1, can include a physical memory protection (PMP) element, such as PMP 722 for core 0, PMP 742 for core 1, and PMP 762 for core N−1. In a processor architecture such as the RISC-V® architecture, a PMP can enable processor firmware to specify one or more regions of physical memory such as cache memory of the shared memory, and to control permissions to access the regions of physical memory. The cores can include a memory management unit (MMU) such as MMU 724 for core 0, MMU 744 for core 1, and MMU 764 for core N−1. The memory management units can translate virtual addresses used by software running on the cores to physical memory addresses with caches, the shared memory system, etc.

The processor cores associated with the multicore processor 710 can include caches such as instruction caches and data caches. The caches, which can comprise level 1 (L1) caches, can include an amount of storage such as 16 KB, 32 KB, and so on. The caches can include an instruction cache I$ 726 and a data cache D$ 728 associated with core 0, an instruction cache I$ 746 and a data cache D$ 748 associated with core 1, and an instruction cache I$ 766 and a data cache D$ 768 associated with core N−1. In addition to the level 1 instruction and data caches, each core can include a level 2 (L2) cache. The level 2 caches can include L2 cache 730 associated with core 0, L2 cache 750 associated with core 1, and L2 cache 770 associated with core N−1. The cores associated with the multicore processor 710 can include further components or elements. The further elements can include a level 3 (L3) cache 712. The level 3 cache, which can be larger than the level 1 instruction and data caches, and the level 2 caches associated with each core, can be shared among all of the cores. The further elements can be shared among the cores. In one or more implementations, the further elements can include a platform level interrupt controller (PLIC) 714. The platform-level interrupt controller can support interrupt priorities, where the interrupt priorities can be assigned to each interrupt source. The PLIC source can be assigned a priority by writing a priority value to a memory-mapped priority register associated with the interrupt source. The PLIC can be associated with an advanced core local interrupter (ACLINT). The ACLINT can support memory-mapped devices that can provide inter-processor functionalities such as interrupt and timer functionalities. The inter-processor interrupt and timer functionalities can be provided for each processor. The further elements can include a joint test action group (JTAG) element 716. The JTAG can provide a boundary within the cores of the multicore processor. The JTAG can enable fault information to a high precision. The high-precision fault information can be critical to rapid fault detection and repair.

The multicore processor 710 can include one or more interface elements 718. The interface elements can support standard processor interfaces including an Advanced eXtensible Interface (AXI®) such as AXI4®, an ARM® Advanced eXtensible Interface (AXI®) Coherence Extensions (ACE®) interface, an Advanced Microcontroller Bus Architecture (AMBA®) Coherence Hub Interface (CHI®), etc. In the block diagram 700, the interface elements can be coupled to the interconnect. The interconnect can include a bus, a network, and so on. The interconnect can include an AXI® interconnect 780. In one or more implementations, the network can include network-on-chip functionality. The AXI® interconnect can be used to connect memory-mapped “master” or boss devices to one or more “slave” or worker devices. In the block diagram 700, the AXI interconnect can provide connectivity between the multicore processor 710 and one or more peripherals 790. The one or more peripherals can include storage devices, networking devices, and so on. The peripherals can enable communication using the AXI® interconnect by supporting standards such as AMBA® version 4, among other standards.

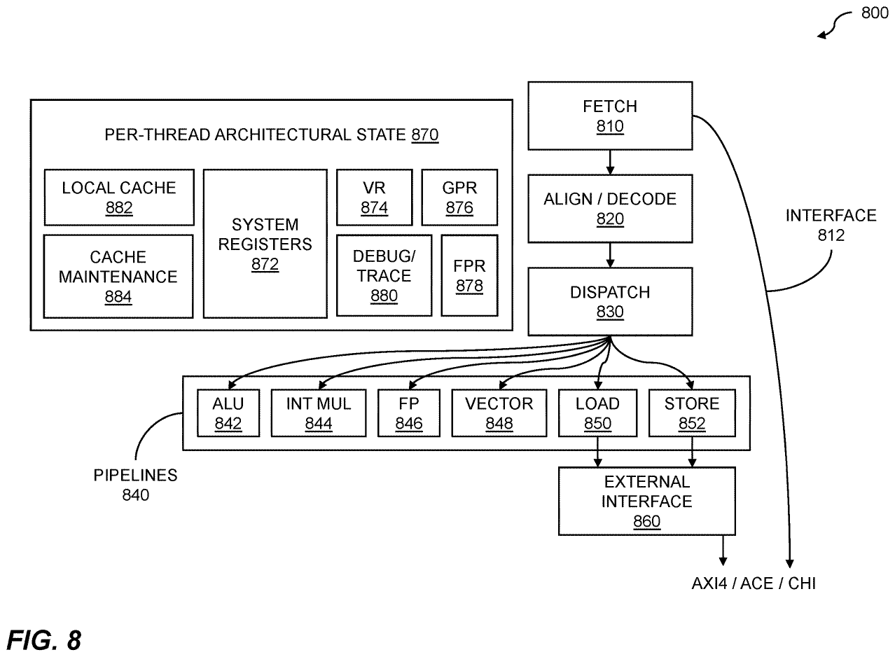

FIG. 8 is a block diagram of a pipeline. One or more pipelines associated with a processor architecture can be used to greatly enhance processing throughput. The processor architecture can be associated with one or more processor cores. The processing throughput can be increased because multiple operations can be executed in parallel. In one or more implementations, a processor core is accessed. The processor core is coupled to a memory hierarchy, and the processor core is configured to execute vector operations, scalar operations, and various micro-operations that implement architectural instructions.

The blocks within the block diagram can be configurable in order to provide varying processing levels. The varying processing levels can be based on processing speed, bit lengths, word lengths, numbers of micro-operations, and so on. The block diagram 800 can include a fetch block 810. The fetch block 810 can read a number of bytes from a cache such as an instruction cache (not shown). The number of bytes that are read can include 16 bytes, 32 bytes, 64 bytes, and so on. The fetch block can include branch prediction techniques, where the choice of branch prediction technique can enable various branch predictor configurations. The fetch block can access memory through an interface 812. The interface can include a standard interface such as one or more industry standard interfaces. The interfaces can include an Advanced eXtensible Interface (AXI®), an ARM® Advanced eXtensible Interface (AXI®) Coherence Extensions (ACE®) interface, an Advanced Microcontroller Bus Architecture (AMBA®) Coherence Hub Interface (CHI®), etc.

The block diagram 800 includes an align and decode block 820. Operations such as data processing operations can be provided to the align and decode block by the fetch block. The align and decode block can partition a stream of operations provided by the fetch block. The stream of operations can include operations of differing bit lengths, such as 16 bits, 32 bits, and so on. The align and decode block can partition the fetch stream data into individual operations. The operations can be decoded by the align and decode block to generate decoded packets. The decoded packets can be used in the pipeline to manage execution of operations. The block diagram 800 can include a dispatch block 830. The dispatch block can receive decoded instruction packets from the align and decode block. The decoded instruction packets can be used to control a pipeline 840, where the pipeline can include an in-order pipeline, an out-of-order (OoO) pipeline, etc. In one or more exemplary implementations, the processor core executes one or more instructions out of order. A pipeline can be associated with the one or more execution units. The pipelines associated with the execution units can include processor cores, arithmetic logic unit (ALU) pipelines 842, integer multiplier pipelines 844, floating-point unit (FPU) pipelines 846, vector unit (VU) pipelines 848, and so on. The dispatch unit can further dispatch instructions to pipelines that can include load pipelines 850 and store pipelines 852. The load pipelines and the store pipelines can access storage such as the common memory using an external interface 860. The external interface can be based on one or more interface standards such as the Advanced eXtensible Interface (AXI®). Following execution of the instructions, further instructions can update the register state. Other operations can be performed based on actions that can be associated with a particular architecture. The actions that can be performed can include executing instructions to update the system register state, trigger one or more exceptions, and so on.

In one or more exemplary implementations, the plurality of processors can be configured to support multi-threading. The system block diagram can include a per-thread architectural state block 870. The inclusion of the per-thread architectural state can be based on a configuration or architecture that can support multi-threading. In one or more exemplary implementations, thread selection logic can be included in the fetch and dispatch blocks discussed above. The per-thread architectural state can include system registers 872. The system registers can be associated with individual processors, a system comprising multiple processors, and so on. The system registers can include exception and interrupt components, counters, etc. The per-thread architectural state can include further registers such as vector registers (VRs) 874. The vector registers can be grouped in a vector register file and can be used for vector operations. In one or more exemplary implementations, the width of the vector register file is 512 bits. Additional registers, such as general-purpose registers (GPRs) 876 and floating-point registers (FPRs) 878, can be included. These registers can be used for general purpose (e.g., integer) operations and floating-point operations, respectively. The per-thread architectural state can include a debug and trace block 880. The debug and trace block can enable debug and trace operations to support code development, troubleshooting, and so on. In one or more exemplary implementations, an external debugger can communicate with a processor through a debugging interface such as a joint test action group (JTAG) interface. The per-thread architectural state can include a local cache state 882. The architectural state can include one or more states associated with a local cache such as a local cache coupled to a grouping of two or more processors. The local cache state can include clean or dirty, zeroed, flushed, invalid, and so on. The per-thread architectural state can include a cache maintenance state 884. The cache maintenance state can include maintenance needed, maintenance pending, and maintenance complete states, etc.

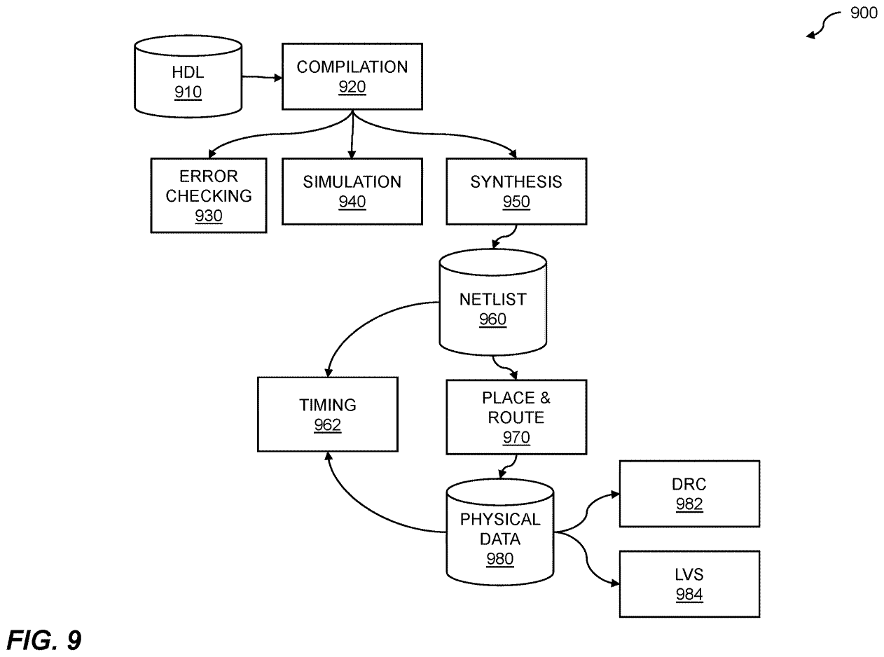

FIG. 9 is a design flow for semiconductor logic generation. Semiconductor logic generation can enable manufacture of a semiconductor that supports accelerated tagged geometric (TAGE) branch prediction with a TAGE cache. The design flow can be based on one or more design automation tools and can include instructions and/or functions for design, generation of semiconductor logic for, and implementation of integrated circuits that support non-flushing vector micro-operations with vector set (VSET). The design flow 900 can include instructions and/or functions for generation and/or manipulation of design data such as hardware description language (HDL) constructs for specifying structure and operation of an integrated circuit. The design flow 900 can further perform operations to generate and manipulate register level transfer (RTL) abstractions. These abstractions can include parameterized inputs that enable specifying elements of a design such as a number of elements, sizes of various bit fields, sizes of caches, number of registers, enablement of certain features (such as architectural extensions), and so on. The parameterized inputs can be used as inputs to a logic synthesis process which can create semiconductor logic that implements the gate-level abstraction of the HDL. The gate level data can be further processed and used for fabrication of integrated circuit (IC) devices.

Modern integrated circuit designs are typically created using complex software design automation tools. The design flow 900 includes a hardware description language (HDL) 910 of a logic design. The HDL can enable a human to create and test a description of a logic function, logic block, system, etc. they want to design by describing the system using code. Any HDL can be used, including Verilog®, VHDL, SystemC, Chisel, and other languages. The code can describe the system at various levels of abstraction. The levels of abstraction can include a high level of abstraction that describes the behavior of the system, at a register transfer level (RTL), which describes the design based on the transfer of data between registers; at a gate level description, which names the particular circuits used and the interconnections between them; and so on. For example, a high level behavioral description may describe multiplication as C=A*B. An RTL level may describe loading data into register A, loading data into register B, performing a multiplication operation, and storing the product of A and B in register C. A circuit level description may name the particular circuits to use and the interconnections among them. At the RTL stage, disclosed implementations can capture both functional behavior and timing relationships. While the behavioral description can be the most user friendly, the RTL description can enable more control over how the design is implemented. Common text file formats, such as “.v”, “.vhd”, are typically used for the HDL source code in the semiconductor design flow.

The HDL source code can be compiled 920. The compilation can comprise one or more analysis, parsing, and/or elaboration steps. The compilation can result in an executable model of the HDL source code, which can be suitable for further steps of design automation. The executable model can be hierarchical. The compilation process can include error checking 930. The error checking can include syntactical checking; semantic checking; checking of references to other referenced libraries, designs, and models; etc. One or more implementations may include automated linting tools that detect undeclared signals, mismatched bit widths, or unused variables in HDL code.

One or more implementations may include simulation 940 of the HDL or RTL code prior to synthesis. Simulation environments can enable verification of design parameters such as functional correctness, timing behavior, and corner cases. By running testbenches against the HDL code, designers can confirm that arbitration logic operates as intended before committing to gate level synthesis. Simulation can also provide visibility into signal waveforms and processor request interactions, ensuring that arbitration criteria are correctly enforced. One or more implementations may also address conflicts that arise in visualization and reporting. For example, waveform viewers and schematic generators may use color coding to distinguish signals, buses, and states. Conflicts in color assignments or overlapping graphical elements can obscure analysis. Tools therefore include configurable color palettes and conflict resolution mechanisms to ensure clarity in simulation results and design documentation.

Synthesis 950 tools can be used to map the abstract operations captured by the HDL code into logic gates, flip-flops, cache structures, interconnect structures, etc. This process can enable automated generation of semiconductor logic that can be implemented in silicon, while preserving the intended arbitration and control functions originally specified. The synthesis can produce a gate level netlist 960 that represents the actual semiconductor logic structures such as described above. The netlist can be a technology-mapped netlist (e.g., mapped to a specific semiconductor fabrication technology). Synthesized netlists may be represented in formats such as EDIF, Liberty, and so on. In some implementations, checking can be performed to ensure that the logic generated by the synthesis tool is equivalent to the logic defined by the HDL source code. This can be accomplished by one or more testbenches, running one or more tests on larger blocks of logic and comparing those to the synthesized circuits, performing formal verification to prove logical equivalence between HDL and the netlist, and so on. Timing 962 can be performed on the netlist. The timing can generate an initial view including critical paths and/or paths that should be retimed with different synthesis directions. The timing information can be generated from established models of semiconductor devices, gates, etc. that have been selected by the synthesis tool. Estimates for wiring delays can also be included in the timing data.

The gate level netlist can be placed and routed 970 to produce physical data 980 which represents layout suitable for fabrication. Examples of place and route tools are Cadence® Innovus®, Synopsis IC complier®, versatile place and route (VPR), nextpnr, and others. Layout data is often exchanged in GDSII or OASIS formats. These standardized formats enable interoperability across tools and vendors, and support error checking during import/export. Timing 962 can again be run on the placed and routed design to ensure that the design meets cycle time requirements, taking into account more accurate wire lengths, parasitics, clock domains, and so on. Design rule checks (DRCs) 982 and layout versus schematic (LVS) 984 checks can confirm that the generated semiconductor logic adheres to fabrication constraints and matches the intended design. This tool-based flow demonstrates how software code can be transformed into concrete semiconductor logic structures, enabling support for claims directed to logic generation.

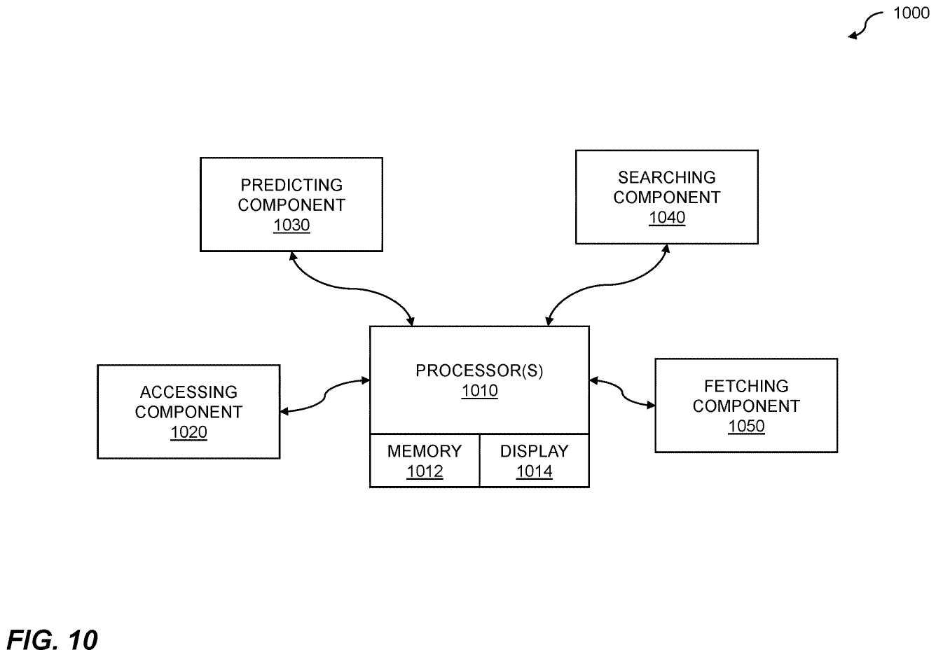

FIG. 10 is a system diagram for accelerated TAGE branch prediction with a TAGE cache. The system 1000 can include instructions and/or functions for design, generation of semiconductor logic for, and implementation of integrated circuits that support accelerated TAGE branch prediction with a TAGE cache. The system 1000 can include instructions and/or functions for generation and/or manipulation of design data such as hardware description language (HDL) constructs for specifying structure and operation of an integrated circuit. The system 1000 can further perform operations to generate and manipulate register level transfer (RTL) abstractions. These abstractions can include parameterized inputs that enable specifying elements of a design such as a number of elements, sizes of various bit fields, and so on. The parameterized inputs can be input to a logic synthesis tool which in turn creates the semiconductor logic that includes the gate-level abstraction of the design that is used for fabrication of integrated circuit (IC) devices.

The system can include one or more of processors, memories, cache memories, displays, and so on. The system 1000 can include one or more processors 1010. The processors can include standalone processors, processors within integrated circuits or chips, processor cores in FPGAs or ASICs, and so on. The one or more processors 1010 are coupled to a memory 1012, which stores instructions. The memory can include one or more of local memory, cache memory, system memory, etc. The system 1000 can further include a display 1014 coupled to the one or more processors 1010. The display 1014 can be used for displaying data, instructions, operations, micro-operations, operations using accelerated TAGE branch prediction with a TAGE cache, and the like. The operations can include instructions and functions for implementation of integrated circuits, including processor cores. In exemplary implementations, the processor cores can include RISC-V® processor cores. A system comprising the one or more processors 1010, when executing the instructions which are stored in the memory 1012, is configured to enable accelerated TAGE branch prediction with a TAGE cache.

The system 1000 can include an accessing component 1020. The accessing component 1020 can include functions and instructions for accessing a processor core, wherein the processor core is coupled to a memory hierarchy, and wherein the processor core is configured to perform TAGE branch prediction with a TAGE cache. The processor core can include an ARM core, a MIPS core, and/or other suitable core type. In one or more exemplary implementations, the processor core can include a RISC-V architecture. The processor core can be configured to execute instructions and/or micro-operations. The accessing can include accessing a processor core, wherein the processor core executes a plurality of instructions, and wherein the processor core includes a tagged geometric (TAGE) branch predictor and a TAGE cache.

The system 1000 can include a predicting component 1030. The predicting component 1030 can include functions and instructions for predicting, by the processor core, a conditional branch instruction, wherein the predicting is based on the TAGE branch predictor, and wherein the predicting results in a first prediction. The first prediction can correspond to a “taken” or “not taken” outcome associated with the conditional branch instruction, enabling the processor to speculatively fetch and execute subsequent instructions. Thus, the first prediction can be a prediction from a TAGE branch predictor such as depicted in FIG. 5. The TAGE branch predictor can include multiple stages, each indexed using a combination of the program counter (PC) and a segment of the global history register. In some implementations, the stages of the TAGE branch predictor do not need to be strictly geometric. As an example, some implementations may utilize a non-geometric progression of stages, such as a 4-bit stage, 8-bit stage, and 48-bit stage. This flexible configuration enables designers to target specific performance or hardware constraints, allowing for fine-tuning of prediction granularity and storage overhead. Additionally, longer history stages can improve prediction accuracy for deeply nested or infrequent branching patterns, while shorter stages can provide faster access and reduced latency.

The system 1000 can include a searching component 1040. The searching component 1040 can include functions and instructions for searching, in the TAGE cache, for a previous TAGE prediction associated with the conditional branch instruction, wherein the predicting and the searching occur in parallel. The TAGE cache can include a TAGE cache, such as shown in FIG. 6, that is capable of returning a result (TAGE cache hit) in one cycle, thereby exceeding the likely performance from the TAGE branch predictor. In disclosed implementations, the TAGE cache can be a set associative cache implemented via SRAM.

The system 1000 can include a fetching component 1050. The fetching component 1050 can include functions and instructions for fetching, by the processor core, from an instruction cache, a next instruction, wherein the fetching is based on the predicting and the searching. When a TAGE cache miss occurs, the fetching can be based on the prediction results provided by the TAGE branch predictor. When a TAGE cache hit occurs, the fetching can be based on the prediction results provided by the TAGE cache. In disclosed implementations, the results of a TAGE cache hit are subsequently compared with results from the TAGE branch predictor. If the results agree, the speculative fetch continues to completion. If the results differ, the TAGE branch predictor results can take precedence, the speculative fetch can be restarted based on the TAGE branch predictor results, and the TAGE cache can be updated to reflect the most recent results from the TAGE branch predictor. In some implementations, confidence information or prediction strength may also be used when resolving discrepancies between the TAGE cache and TAGE branch predictor results. In this way, disclosed implementations can improve overall processor performance by reducing the overall time required to obtain branch prediction results, enabling earlier instruction fetch and improving instruction throughput.

The system 1000 can include a computer program product embodied in a non-transitory computer readable medium for instruction execution, the computer program comprising code which causes one or more processors to generate semiconductor logic for: accessing a processor core, wherein the processor core executes a plurality of instructions, and wherein the processor core includes a tagged geometric (TAGE) branch predictor and a TAGE cache; predicting, by the processor core, a conditional branch instruction, wherein the predicting is based on the TAGE branch predictor, and wherein the predicting results in a first prediction; searching, in the TAGE cache, for a previous TAGE prediction associated with the conditional branch instruction, wherein the predicting and the searching occur in parallel; and fetching, by the processor core, from an instruction cache, a next instruction, wherein the fetching is based on the predicting and the searching.

The system 1000 can include a computer system for instruction execution comprising: a memory which stores instructions; one or more processors attached to the memory, wherein the one or more processors, when executing the instructions which are stored, are configured to: access a processor core, wherein the processor core executes a plurality of instructions, and wherein the processor core includes a tagged geometric (TAGE) branch predictor and a TAGE cache; predict, by the processor core, a conditional branch instruction, wherein the predicting is based on the TAGE branch predictor, and wherein the predicting results in a first prediction; search, in the TAGE cache, for a previous TAGE prediction associated with the conditional branch instruction, wherein the predicting and the searching occur in parallel; and fetch, by the processor core, from an instruction cache, a next instruction, wherein the fetching is based on the predicting and the searching.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system” may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented (processor-implemented) methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for instruction execution comprising:
accessing a processor core, wherein the processor core executes a plurality of instructions, and wherein the processor core includes a tagged geometric (TAGE) branch predictor and a TAGE cache;
predicting, by the processor core, a conditional branch instruction, wherein the predicting is based on the TAGE branch predictor, and wherein the predicting results in a first prediction;
searching, in the TAGE cache, for a previous TAGE prediction associated with the conditional branch instruction, wherein the predicting and the searching occur in parallel; and
fetching, by the processor core, from an instruction cache, a next instruction, wherein the fetching is based on the predicting and the searching.

2. The method of claim 1 wherein the searching results in a hit within the TAGE cache, wherein the searching results in a second prediction.

3. The method of claim 2 wherein the fetching is based on the second prediction.

4. The method of claim 3 further comprising comparing the first prediction with the second prediction.

5. The method of claim 4 further comprising restarting the fetching, wherein the restarting is based on the first prediction, wherein the first prediction and the second prediction do not match.

6. The method of claim 5 further comprising updating the TAGE cache with the first prediction.

7. The method of claim 2 wherein the searching results in a miss within the TAGE cache.

8. The method of claim 7 wherein the fetching is based on the first prediction.

9. The method of claim 8 further comprising updating the TAGE cache with the first prediction.

10. The method of claim 1 wherein the predicting requires two or more cycles of the processor core.

11. The method of claim 10 wherein the searching requires a single cycle of the processor core.

12. The method of claim 2 wherein the TAGE branch predictor comprises a plurality of branch history tables.

13. The method of claim 12 wherein each branch history table within the plurality of branch history tables is accessed by a hash of a program counter and a global history register.

14. The method of claim 13 wherein the global history register includes a global branch history.

15. The method of claim 14 wherein the global branch history comprises 128 bits.

16. The method of claim 14 wherein each branch history table within the plurality of branch history tables comprises a different history length.

17. The method of claim 16 further comprising prioritizing, by the TAGE branch predictor, a result of a branch history table within the plurality of branch history tables associated with a longest history.

18. The method of claim 1 wherein the fetching includes looking up, in a branch target buffer, a target of the conditional branch instruction.

19. A computer program product embodied in a non-transitory computer readable medium for instruction execution, the computer program comprising code which causes one or more processors to generate semiconductor logic for:
accessing a processor core, wherein the processor core executes a plurality of instructions, and wherein the processor core includes a tagged geometric (TAGE) branch predictor and a TAGE cache;
predicting, by the processor core, a conditional branch instruction, wherein the predicting is based on the TAGE branch predictor, and wherein the predicting results in a first prediction;
searching, in the TAGE cache, for a previous TAGE prediction associated with the conditional branch instruction, wherein the predicting and the searching occur in parallel; and
fetching, by the processor core, from an instruction cache, a next instruction, wherein the fetching is based on the predicting and the searching.

20. A computer system for instruction execution comprising:
a memory which stores instructions;
one or more processors coupled to the memory, wherein the one or more processors, when executing the instructions which are stored, are configured to:
access a processor core, wherein the processor core executes a plurality of instructions, and wherein the processor core includes a tagged geometric (TAGE) branch predictor and a TAGE cache;
predict, by the processor core, a conditional branch instruction, wherein the predicting is based on the TAGE branch predictor, and wherein the predicting results in a first prediction;
search, in the TAGE cache, for a previous TAGE prediction associated with the conditional branch instruction, wherein the predicting and the searching occur in parallel; and
fetch, by the processor core, from an instruction cache, a next instruction, wherein the fetching is based on the predicting and the searching.
